(19) United States
(12) Patent Application Publication
(10) Pub. No.: US 2011/0274929 A1
(43) Pub. Date: Nov. 10, 2011

(54) LITHIUM TITANATE AGGREGATE AND METHOD OF PREPARING THE SAME

(75) Inventors: Jong-Hee Lee, Yongin-si (KR); Young-Su Kim, Yongin-si (KR); Yong-Mi Yu, Yongin-si (KR); Jae-Myung Kim, Yongin-si (KR)

(73) Assignee: SAMSUNG SDI CO., LTD., Yongin-si (KR)

(21) Appl. No.: 12/981,462

(22) Filed: Dec. 29, 2010

(30) Foreign Application Priority Data
May 4, 2010 (KR) 10-2010-0042064

(51) Int. Cl. C01G 23/04; B32B 5/16

(52) U.S. Cl. 428/402; 423/598

(57) ABSTRACT

A lithium titanate aggregate and a method of preparing the same. In the lithium titanate aggregate, a single primary particle has a median diameter (D50) of about 8×10⁻² μm to about 3.1×10⁻¹ μm, and has a spherical shape. In addition, an amount of primary particles having a diameter of about 55 nm to about 85 nm is about 55% to about 75% of all primary particles.

### CLAIM OF PRIORITY

This application makes reference to, incorporates the same herein, and claims all benefits accruing under 35 U.S.C. §119 from an application earlier filed in the Korean Intellectual Property Office on 4 May 2010 and there duly assigned Serial No. 10-2010-0042064.

### BACKGROUND OF THE INVENTION

1. Field of the Invention

One or more embodiments of the present invention relate to a lithium titanate aggregate, and a method of preparing the same.

2. Description of the Related Art

A lithium ion battery is a kind of a rechargeable battery that generates electricity by intercalation and deintercalation of lithium ions between a cathode and an anode. The lithium ion rechargeable battery generally includes a cathode, an anode, an electrolyte, and a separator. Cathode and anode active materials as being components of the lithium ion battery constitute a structure enabling lithium ions intercalation and deintercalation by reversible reaction during charging and discharging.

### SUMMARY OF THE INVENTION

One or more embodiments of the present invention include lithium titanate aggregates having a monodisperse spherical shape.

One or more embodiments of the present invention include methods of preparing the lithium titanate aggregates.

Aspects of the present invention will be set forth in part in the description which follows, and, in part, will be apparent from the description, or may be learned by practice of the presented embodiments.

In accordance with one or more embodiments of the present invention, a lithium titanate aggregate includes primary particles, wherein a single primary particle has a median diameter (D50) of about 8×10⁻² μm to about 3.1×10⁻¹ μm, wherein the single primary particle has a spherical shape with a spherical degree (Ψ) of at least 0.97, and wherein an amount of particles having a diameter of about 55 nm to about 85 nm is about 55 to about 75% of all the primary particles: Spherical Degree (Ψ)=short−axis length of the particle/long-axis length of the particle.

A D90 of the primary particles may be about 1.2×10⁻¹ μm to about 6.2×10⁻¹ μm.

A value of (D90−D50) of the primary particles may be about 4×10⁻² μm to about 3.1×10⁻¹ μm.

The primary particles may not be formed into secondary particles.

Lithium titanate (Li₄Ti₅O₁₂) may have a single phase.

According to one or more embodiments of the present invention, a method of preparing lithium titanate (Li₄Ti₅O₁₂) includes steps of forming a mixture by mixing a solvent including an ethylene oxide chain with a lithium material and a titanium material; drying the mixture to prepare a dry mixture including a remaining solvent; and heat-treating the dry mixture.

The solvent may function as a reducing agent and simultaneously as a uniform crystal growth inhibitor.

The solvent may be a polyethylene glycol based solvent.

The solvent may be a polyethylene glycol solvent having a molecular weight of about 100 to about 700.

The lithium material may be one selected from the group consisting of lithium nitrate, lithium acetate, lithium hydroxide, lithium chloride, and mixtures thereof.

The titanium material may be one selected from the group consisting of titanium nitrate, TiCl₄, TiCl₃, titanium alkoxide, and mixtures thereof.

Only the solvent including an ethylene oxide chain in addition to the lithium material and the titanium material may be used without other additives.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a two dimensional graph showing an X-ray analysis result of a lithium titanate aggregate, according to an embodiment of the present invention;

FIG. 2 is a scanning electron microscope (SEM) image of a lithium titanate aggregate according to an embodiment of the present invention;

FIG. 3 is a two dimensional graph showing median particle sizes (D50) of a lithium titanate aggregate varying with different functional solvents according to an embodiment of the present invention;

FIG. 4 is a two dimensional graph showing a measurement result of a particle size distribution of a lithium titanate aggregate according to an embodiment of the present invention;

FIG. 5 is a SEM image of Li₄Ti₅O₁₂ prepared in Comparative Example 1; and

FIG. 6 is a flow chart showing a manufacturing process for making Li₄Ti₅O₁₂ in accordance with an embodiment of the present invention.

### DETAILED DESCRIPTION OF THE INVENTION

In order to develop a lithium ion rechargeable battery having good performances such as higher speed of charging/discharging and longer lifetime, active research has been recently conducted on using lithium titanate (Li₄Ti₅O₁₂), which is a metal oxide having a spinel structure, as an anode active material. Li₄Ti₅O₁₂ does not generate a solid state interphase (SEI) that is generated in an accompanying reaction between a graphite-based anode active material and an electrolyte. Li₄Ti₅O₁₂ is therefore much better than graphite in terms of irreversible capacity, and has excellent reversibility for lithium ions intercalation and deintercalation in repetitive charging/discharging cycles. In addition, Li₄Ti₅O₁₂ is very stable in terms of structure, and thus Li₄Ti₅O₁₂ may lead to improved performances of a rechargeable battery, such as longer lifetime.

Lithium titanate (Li₄Ti₅O₁₂) having a spinel structure is capable of being rapidly charged and discharged, and the volume of Li₄Ti₅O₁₂ powders is barely expanded during charge/discharge. Li₄Ti₅O₁₂ therefore has excellent stability and long lifetime, and has attracted considerable attention as a negative active material of a lithium ion battery. Li₄Ti₅O₁₂ does not generate a solid state interphase (SEI) that is generated in an accompanying reaction between a graphite-based anode active material and an electrolyte, and also has excellent reversibility.

As a particle size of Li₄Ti₅O₁₂ is further fined, that is, as the particle size is closer to a nano size, a charge/discharge speed of a battery may be advantageously increased and output performance may be improved. In a solid-state synthesis method, as a typical method of preparing Li₄Ti₅O₁₂, a reaction is performed without any medium under a high-temperature condition, and a diameter of a resultant is about several micrometers (μm). The solid-state synthesis method is therefore inappropriate to realize Li₄Ti₅O₁₂ having particle side in nanometer range, and there is a need for a method of realizing Li₄Ti₅O₁₂ having a nano size.

Reference will now be made in detail to embodiments, examples of which are illustrated in the accompanying drawings.

In accordance with an embodiment of the present invention, a lithium titanate aggregate includes primary particles, wherein a single primary particle has a median diameter (D50) of about 8×10⁻² μm to about 3.1×10⁻¹ μm, wherein the single primary particle has a spherical shape with a spherical degree (Ψ) of at least 0.97, and wherein an amount of primary particles having a diameter of about 55 nm to about 85 nm is about 55% to about 75% of all of the primary particles, which will be referred to as a ‘particle size distribution A’.

$$Spherical Degree ( Ψ ) = \frac{short \text{-} axis length of the particle}{long \text{-} axis length of the particle} .$$

A D90 of the primary particles may be about 1.2×10⁻¹ μm to about 6.2×10⁻¹ μm.

A value of (D90−D50) of the primary particles may be about 4×10⁻² μm to about 3.1×10⁻¹ μm.

D50 and D90 denote particle diameters respectively corresponding to 50% and 90% on cumulative distribution percentage among all particles, and the value of (D90−D50) denotes the difference between the particle diameter corresponding to 90% and the particle diameter corresponding to 50% on cumulative distribution percentage. For example, the amount of particles having diameters zero to D50 is 50% of the total amount of the particles, and the amount of particles having diameters zero to D90 is 90% of the total amount of the particles.

An average diameter denotes an average particle size of powders by weighted average on particle size distribution. For example, the average diameter may equal to a value of

$${\sum }_{i} {s}_{i} \times {A}_{i}$$

where sᵢ denotes a particle size and Aᵢ denotes the percentage of particles having the size of sᵢ among all of particles.

A lithium ion rechargeable battery having primary particles with a sharp particle size distribution such as the particle size distribution A has an increased charge/discharge speed, and an improved output performance. The sharp particle size distribution means that the particles have particles sizes within a smaller range.

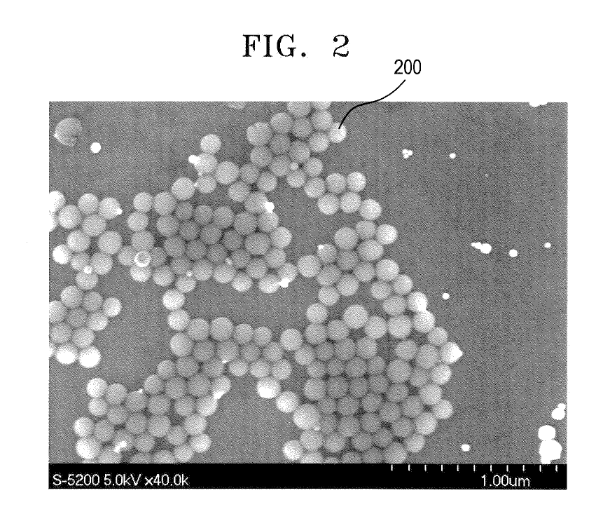

FIG. 2 is a scanning electron microscope (SEM) image of a lithium titanate aggregate according to an embodiment of the present invention.

Referring to FIG. 2, primary particles 200 remain their original forms and are not formed into secondary particles. That is, the primary particles are not agglomerated. When the lithium titanate aggregate is prepared by using a method according to an embodiment of the present invention, the lithium titanate aggregate has a single primary particle having a size of the above-mentioned median diameter (D50), has a spherical shape, and has the particle size distribution A.

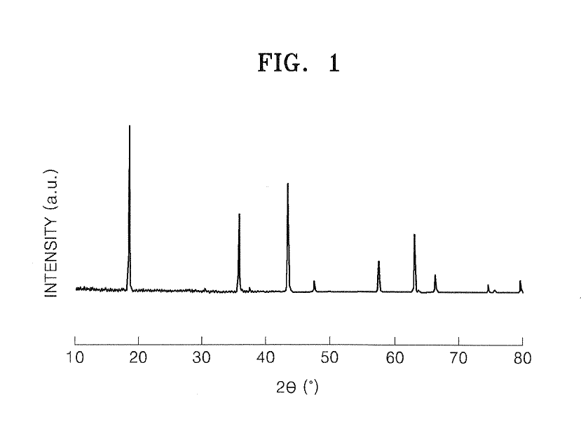

FIG. 1 is a graph showing an X-ray analysis result of a lithium titanate aggregate, according to an embodiment of the present invention.

Referring to FIG. 1, Li₄Ti₅O₁₂ may have a single phase.

A single particle of the lithium titanate aggregate has a spherical shape. A shape of an active material used to form a battery is very important. An active material having a spherical shape is advantageous for easily preparing an electrode and for increasing a packing intensity, and thus the active material may increase the capacity of a battery. Each peak in FIG. 1 presents a crystal facet of Li₄Ti₅O₁₂.

Accordingly, a technology of preparing an active material in a spherical shape is necessary to commercialize a lithium ion rechargeable battery that is highly stable and that may be rapidly charged and discharged. The single primary particle of the lithium titanate aggregate may have a spherical shape with a spherical degree (Ψ) of at least 0.97.

$$Spherical Degree ( Ψ ) = \frac{short \text{-} axis length of the particle}{long \text{-} axis length of the particle} .$$

In accordance with the above equation, when the spherical degree of a particle is closer to 1, the particle has a shape closer to a perfect sphere.

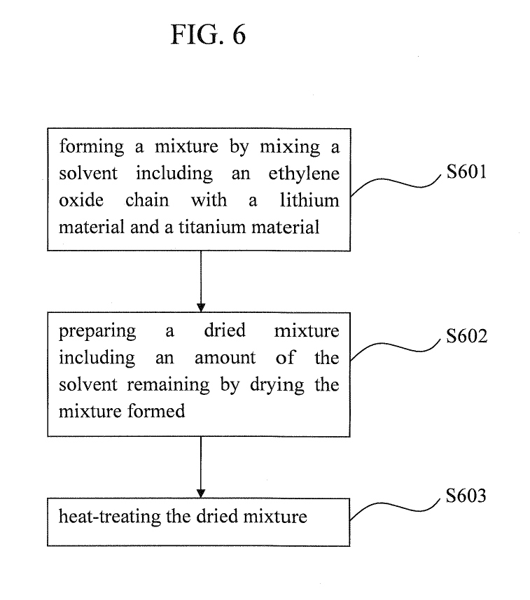

In accordance with an embodiment of the present invention, as shown in FIG. 6, a method of preparing Li₄Ti₅O₁₂ includes steps of mixing a solvent including an ethylene oxide chain with a lithium material and a titanium material (S601); drying the mixture in order to prepare a dried mixture including a remaining solvent (S602); and heat-treating the dried mixture (S603).

With regard to the amounts of the solvent, the lithium material, and the titanium material, the amounts of the titanium material and the solvent may be, for example, about 340 to about 350 parts by weight, and about 2000 to about 3000 parts by weight, respectively, based on 100 parts by weight of the lithium material. Within this range, the lithium titanate aggregate may be easily prepared to have the particle size distribution A.

The drying may be performed, for example, under a general atmospheric condition or under the presence of the inert gas. In this case, an inert gas such as argon (Ar) or helium (He) may be used, or alternatively nitrogen (N) may be used.

The drying may be performed for about 12 to about 24 hours at a temperature within about 180° C. to about 220° C., and within these ranges, polyethylene glycol selected as the solvent may not be completely removed, and a dry mixture including remaining polyethylene glycol may be obtained.

The amount of the remaining polyethylene glycol may be about 5 to about 60 parts by weight, for example, about 5 to about 20 parts by weight, based on 100 parts by weight of the dry mixture.

The heat-treating may be performed for about 1.8 hours to about 2.5 hours at a temperature environment where the temperature increases by about 5° C. to about 7° C. every minute. When the heat-treating is performed within these ranges, the remaining polyethylene glycol included in the dry mixture is carbonized. Thus, crystal growth of lithium particles is prohibited, and thus the primary particle of Li₄Ti₅O₁₂ with the nano size may be formed.

According to an embodiment of the present invention, the solvent including an ethylene oxide chain is used as a reaction field to provide strong reducing power, and thus generation of a great amount of nuclei and uniform crystal growth may be induced, thereby preparing Li₄Ti₅O₁₂ within a short period of time.

In accordance with an embodiment of the present invention, the solvent may function as a reducing agent and simultaneously as a uniform crystal growth inhibitor. Thus, the solvent including an ethylene oxide chain may be used as the reducing agent and as the uniform crystal growth inhibitor.

Examples of the solvent may include an ethylene glycol based solvent and a poly ethylene glycol based solvent. The molecular weight of the solvent may be about 100 to about 700.

When a molecular amount of the solvent exhibits monodisperse distribution, the prepared Li₄Ti₅O₁₂ may exhibit monodisperse distribution.

As the number of ethylene oxide chains of the solvent is increased, hydrogen bond power is increased. Thus, reducing power is increased, multinuclei may be generated, and nano-sized crystals may be grown due to an ether group. Within the above-mentioned range of the molecular weight, good fluidity may be obtained, and a maximum amount of nuclei may be generated. Thus, growth of uniform crystals may be induced, and Li₄Ti₅O₁₂ may be prepared within a short period of time, thereby reducing preparing costs of Li₄Ti₅O₁₂.

In accordance with an embodiment of the present invention, the lithium material may be one selected from the group consisting of lithium nitrate, lithium acetate, lithium hydroxide, lithium chloride, and mixtures thereof. Lithium carbonate may be not selected since lithium carbonate has low solubility and a great amount of solvent is required.

In accordance with an embodiment of the present invention, the titanium material may be one selected from the group consisting of titanium nitrate, TiCl₄, TiCl₃, titanium alkoxide, and mixtures thereof.

In accordance with an embodiment of the present invention, only a solvent including an ethylene oxide chain in addition to a lithium material and a titanium material may be used without other additives.

Hereinafter, one or more embodiments of the present invention will be described in detail with reference to the following examples. However, these examples are not intended to limit the purpose and scope of the one or more embodiments of the present invention.

### EXAMPLES

### Example 1

450 parts by weight of polyethylene glycol (Mw 200) was input into a reactor under a nitrogen atmosphere, and was preheated to a temperature of 160° C. Then, 20 parts by weight of lithium nitrate was put into the reactor, and then the mixture was completely dissolved. 68 parts by weight of titanium chloride was put into the reactor, and then the mixture was stirred for 20 minutes while a temperature of 160° C. was maintained.

After the reaction was completed, a heat source was removed, and then the mixture was cooled in the air. The obtained material (hereinafter, referred to as a ‘sol’) including a lithium-titanium precursor was in a white sol-state. In order to remove a solvent as a reaction field, the sol was put into a suction flask, and was divided into a solid and a liquid by using a vacuum distillation device. Then, a lithium-titanium precursor powder was collected, and was dried at a temperature of 200° C. to prepare a dried mixture including a remaining solvent. The amount of the remaining solvent was 20 parts by weight based on 100 parts by weight of the dried mixture.

The dried powder was heat-treated under an oxygen atmosphere for 5 hours at a temperature of 750° C. and a temperature environment where the temperature increases by 5° C. every minute. Then, the dried powder was fined in a final pulverizer to prepare a final Li₄Ti₅O₁₂ powder having a spinel structure.

As shown in FIG. 1, as an analysis result of a phase, Li₄Ti₅O₁₂ having a single phase may be obtained, and Li₄Ti₅O₁₂ has a uniform particle with a median diameter (D50) of 8×10⁻² μl. In FIG. 2 is a scanning electron microscope (SEM) image of a lithium titanate aggregate according to an embodiment of the present invention. The obtained Li₄Ti₅O₁₂ has an average spherical degree (Ψ) of at least 0.97.

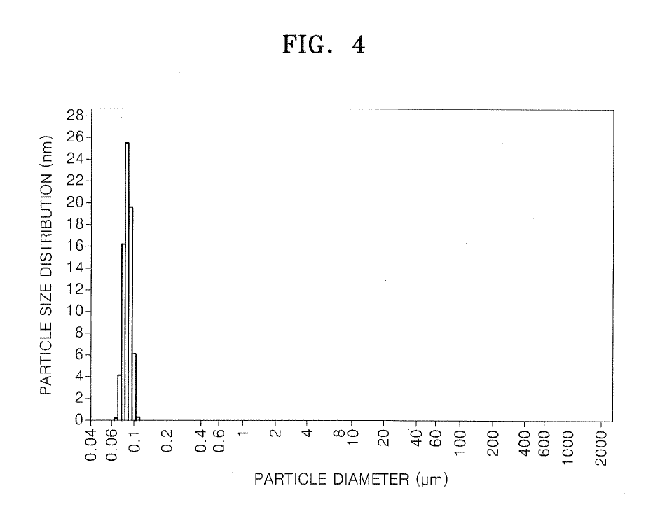

As a measurement result of a particle size distribution of the obtained Li₄Ti₅O₁₂ powder, the amount of particles having a diameter of about 70 nm to about 80 nm is about 65% to about 75% of all particles of the Li₄Ti₅O₁₂ powder, which is shown in FIG. 4.

A D90 of Li₄Ti₅O₁₂ was 1.2×10⁻¹ μm, and D90−D50 was 4×10⁻² μm.

### Example 2

450 parts of polyethylene glycol (Mw 400) was input into a reactor under a nitrogen atmosphere and was preheated to a temperature of 160° C. Then, 20 parts by weight of lithium nitrate was put into the reactor, and then the mixture was completely dissolved. 68 parts by weight of titanium chloride was put into the reactor, and then the mixture was stirred for 20 minutes while a temperature of 160° C. was maintained.

After the reaction was completed, a heat source was removed, and then the mixture was cooled in the air. The obtained material (hereinafter, referred to as a ‘sol’) including a lithium-titanium precursor was in a white sol-state. In order to remove a solvent as a reaction field, the sol was put into a suction flask, and was divided into a solid and a liquid by using a vacuum distillation device. Then, a lithium-titanium precursor powder was collected, and was dried at a temperature of 200° C. to prepare a dry mixture including a remaining solvent. The amount of the remaining solvent was 20 parts by weight based on 100 parts by weight of the dry mixture.

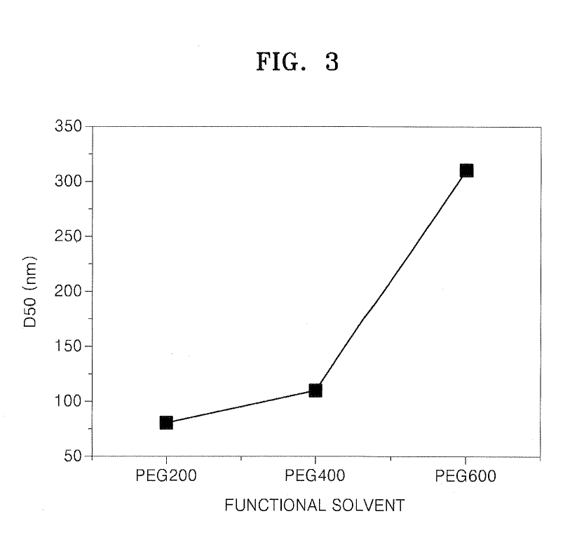

The dried powder was heat-treated under an oxygen atmosphere for 5 hours at a temperature of 750° C. and a temperature environment where the temperature increases by 5° C. every minute. Then, the dried powder was fined in a final pulverizer to prepare a final Li₄Ti₅O₁₂ powder having a spinel structure. In FIG. 3, the final Li₄Ti₅O₁₂ powder has a D50 of 1.1×10⁻¹ μm according to a change of the type of a functional solvent. In FIG. 3, the functional solvent PEG 200 refers to polyethylene glycol 200, PEG 400 refers to polyethylene glycol 400, and PEG 600 refers to polyethylene glycol 600. An average spherical degree of the obtained Li₄Ti₅O₁₂ is at least 0.98.

As a measurement result of a particle size distribution of the obtained Li₄Ti₅O₁₂ powder, the amount of particles having a diameter of about 55 nm to about 65 nm is about 60 to about 70% of all particles of the Li₄Ti₅O₁₂ powder.

A D90 of Li₄Ti₅O₁₂ was 2.4×10⁻¹ μm, and D90−D50 was 1.3×10⁻¹μm.

### Example 3

450 parts of polyethylene glycol (Mw 600) was input into a reactor under a nitrogen atmosphere and was preheated to a temperature of 160° C. Then, 20 parts by weight of lithium nitrate was put into the reactor, and then the mixture was completely dissolved. 68 parts by weight of titanium chloride was put into the reactor, and then the mixture was stirred for 20 minutes while a temperature of 160° C. was maintained.

After the reaction was completed, a heat source was removed, and then the mixture was cooled in the air. The obtained material (hereinafter, referred to as a ‘sol’) including a lithium-titanium precursor was in a white sol-state. In order to remove a solvent as a reaction field, the sol was put into a suction flask, and was divided into a solid and a liquid by using a vacuum distillation device. Then, a lithium-titanium precursor powder was collected, and was dried at a temperature of 200° C. to prepare a dry mixture including a remaining solvent. The amount of the remaining solvent was 20 parts by weight based on 100 parts by weight of the dry mixture.

The dried powder was heat-treated under an oxygen atmosphere for 5 hours at a temperature of 750° C. and a temperature environment where the temperature increases by 5° C. every minute. Then, the dried powder was fined in a final pulverizer to prepare a final Li₄Ti₅O₁₂ powder having a spinel structure. In FIG. 3, the final Li₄Ti₅O₁₂ powder has a D50 of 3.1×10⁻¹ μm according to a change in a functional solvent. An average spherical degree of the obtained Li₄Ti₅O₁₂ is at least 0.97.

As a measurement result of a particle size distribution of the obtained Li₄Ti₅O₁₂ powders, the amount of particles having a diameter of about 60 nm to about 85 nm is about 55 to about 65% of all particles of the Li₄Ti₅O₁₂ powder.

A D90 of Li₄Ti₅O₁₂ was 6.2×10⁻¹ μm, and D90−D50 was 3.1×10⁻¹ μm.

### Comparative Example 1

16.1 parts by weight of lithium carbonate and 43.5 parts by weight of titania were put into a mixer by dry process, and were mixed for 30 minutes.

The obtained mixed powder was sintered under an oxygen atmosphere for 5 hours at a temperature of 850° C. and a temperature environment where the temperature increases by 5° C. every minute, and were cooled to a room temperature. The sintered obtained material was pulverized and fined by using a pulverizer to obtain a final material.

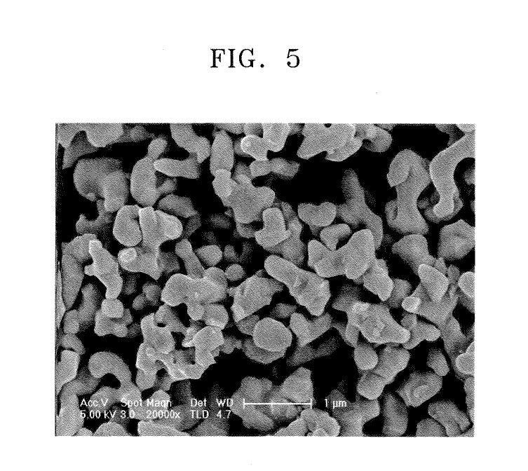

FIG. 5 is a SEM image of Li₄Ti₅O₁₂ prepared in Comparative Example 1. A D50 of Li₄Ti₅O₁₂ is 9.2×10⁻¹ μm, and an average spherical degree (Ψ) is 0.67.

As a measurement result of a particle size distribution of the obtained Li₄Ti₅O₁₂ powder, the amount of particles having a diameter of about 800 nm to 1400 nm is about 50% to about 60% of all particles.

A D90 of Li₄Ti₅O₁₂ was 1.8 gill, and (D90−D50) was 8.8×10⁻¹ μm.

Referring to FIGS. 2 and 5, Li₄Ti₅O₁₂ prepared in Example 1 has an almost perfect spherical shape and exhibits monodisperse distribution, unlike Li₄Ti₅O₁₂ prepared in Comparative Example 1.

As described above, according to the one or more of the above embodiments of the present invention, a solvent including various numbers of ethylene oxide chains is used as a reaction field, and thus the nano size of Li₄Ti₅O₁₂ may be easily adjusted.

In addition, a solvent is used in reaction functions as a reducing agent and as a crystal growth adjuster, and thus reaction materials and processes for obtaining Li₄Ti₅O₁₂ may be simplified. As the number of ethylene oxide chains included in the solvent is increased, a reducing power is increased, and thus Li₄Ti₅O₁₂ may be synthesized within a short period of time.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A lithium titanate aggregate comprising primary particles, wherein a single group of primary particles have a median particle diameter (D50) of about 8×10⁻² μm to about 3.1×10⁻¹ μm, with the median particle diameter (D50) corresponding to 50% on a cumulative distribution percentage among all of the single primary particles,
wherein the single primary particle has a spherical shape with a spherical degree ('F) of at least 0.97, with the spherical degree being a ratio of a short-axis length of the single primary particle to a long-axis length of the single primary particle, and
wherein an amount of primary particles having a diameter of about 55 nm to about 85 nm is about 55% to about 75% of all the primary particles.

2. The lithium titanate aggregate of claim 1, wherein a particle diameter (D90) of the primary particles is about 1.2×10⁻¹ μm to about 6.2×10⁻¹ μm, with the particle diameter (D90) corresponding to 90% on the cumulative distribution percentage among all of the primary particles.

3. The lithium titanate aggregate of claim 1, wherein the difference between the particle diameter (D90) and the median particle diameter (D50) is about 4×10⁻² μm to about 3.1×10⁻¹ μm.

4. The lithium titanate aggregate of claim 1, wherein the primary particles remain original forms and are not formed into secondary particles.

5. The lithium titanate aggregate of claim 1, wherein lithium titanate (Li₄Ti₅O₁₂) has a single phase.

6. A method of preparing lithium titanate (Li₄Ti₅O₁₂), the method comprising:
forming a mixture by mixing a solvent comprising an ethylene oxide chain with a lithium material and a titanium material;
preparing a dried mixture including an amount of the solvent remaining by drying the mixture formed; and
heat-treating the dried mixture.

7. The method of claim 6, wherein the solvent functions as a reducing agent and simultaneously as a uniform crystal growth inhibitor.

8. The method of claim 6, wherein the solvent is a polyethylene glycol based solvent.

9. The method of claim 6, wherein the solvent is a polyethylene glycol solvent having a molecular weight of about 100 to about 700.

10. The method of claim 6, wherein the lithium material is one selected from the group consisting of lithium nitrate, lithium acetate, lithium hydroxide, lithium chloride, and mixtures thereof.

11. The method of claim 5, wherein the titanium material is one selected from the group consisting of titanium nitrate, TiCl₄, TiCl₃, titanium alkoxide, and mixtures thereof.

12. The method of claim 6, wherein only the solvent comprising an ethylene oxide chain in addition to the lithium material and the titanium material is used without other additives.
